(19) United States
(12) Patent Application Publication
(10) Pub. No.: US 2024/0356253 A1
(43) Pub. Date: Oct. 24, 2024

(54) CONNECTOR WITH SMT VERTICAL TAIL TERMINALS

(71) Applicant: Molex, LLC, Lisle, IL (US)

(72) Inventors: Cory R. Ensley, Conway, AR (US); Thomas Woodrow Moeller, Palatine, IL (US); Vivek M. Shah, Buffalo Grove, IL (US)

(21) Appl. No.: 18/616,222

(22) Filed: Mar. 26, 2024

Related U.S. Application Data
(60) Provisional application No. 63/497,882, filed on Apr. 24, 2023.

(51) Int. Cl. H01R 12/70; H01R 12/72

(52) U.S. Cl. CPC H01R 12/707; H01R 12/724

(57) ABSTRACT

Connectors with surface mount vertical tail terminals are described. In one example, a connector includes a housing and a wafer comprising a terminal conductor. The terminal conductor includes a lead contact, a tail contact, and a terminal conductor body extending between the lead contact and the tail contact. According to one aspect of the connector, the wafer and the terminal conductor are arranged vertically in the connector, and the tail contact of the terminal conductor comprises a surface mount tail contact. In other aspects, the terminal conductor includes a side surface, a cut edge surface, and a body bend along the terminal conductor body. The cut edge surface is an edge surface formed from shearing or cutting the terminal conductor out from a lead frame. The surface mount tail contact includes a side surface and a surface mount cut edge surface without a bend in the side surface.

### RELATED APPLICATIONS

The present application claims priority to U.S. Provisional Patent Application No. 63/497,882 filed on Apr. 24, 2023, which is incorporated by reference in its entirety.

### BACKGROUND

A range of input/output (I/O) connectors are designed for power, data, and power and data interconnect systems, including board-to-board, wire-to-wire, and wire-to-board systems. A variety of designs exist for each type of system, depending on the requirements of the power and data communications environment in which the connectors are used. As one example, a wire-to-board system includes a free-end connector attached to a wire and a fixed-end connector attached to a board.

High data rate connectors, cable assemblies, and interconnection systems often rely upon differentially coupled signal pairs in which two conductors are arranged in a pair to transmit a differential signal. The signal being transmitted is embodied by the electrical difference measured between the conductor pair. Differential signaling can be helpful to avoid spurious signals and crosstalk and avoid inadvertent signaling modes among adjacent signals pairs. In connector interfaces, ground terminals can be relied upon to create a return path to electrical ground, provide shielding between differential pairs, and for other purposes.

Connectors used in high data rate applications are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The wafer assemblies can include an insulative web that supports the terminal conductors in the wafer assemblies. The use of wafer assemblies can be helpful to manufacture connectors capable of achieving high data rates using a number of different assembly processes.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a top perspective view of an example connector according to various aspects of the present disclosure.

FIG. 2 illustrates an example wafer of the connector shown in FIG. 1 according to various aspects of the present disclosure.

FIG. 3 illustrates terminal conductors of the wafer shown in FIG. 2 according to various aspects of the present disclosure.

FIG. 4 illustrates a bottom perspective view of the connector shown in FIG. 1 according to various aspects of the present disclosure.

FIG. 5 illustrates another bottom perspective view of the connector shown in FIG. 1 according to various aspects of the present disclosure.

FIG. 6 illustrates a top perspective view of another example connector according to various aspects of the embodiments.

FIG. 7 illustrates an example wafer of the connector shown in FIG. 6 according to various aspects of the embodiments.

FIG. 8 illustrates terminal conductors of the wafer shown in FIG. 6 according to various aspects of the embodiments.

FIG. 9 illustrates another view of the terminal conductors shown in FIG. 8 according to various aspects of the embodiments.

FIG. 10 illustrates an example lead frame for terminal conductors in the connector shown in FIG. 6 according to various aspects of the embodiments.

FIG. 11 illustrates an example tail contact in the connector shown in FIG. 6 according to various aspects of the embodiments.

FIG. 12 illustrates a ground conductor frame in the connector shown in FIG. 6 according to various aspects of the embodiments.

FIG. 13 illustrates a bottom perspective view of the connector shown in FIG. 6 according to various aspects of the embodiments.

FIG. 14 illustrates another bottom perspective view of the connector shown in FIG. 6 according to various aspects of the embodiments.

FIG. 15 illustrates a horizontal style terminal conductor according to various aspects of the embodiments.

FIG. 16 illustrates an example PCB mounting footprint for the connector shown in FIG. 1, with dimensions shown in millimeters.

FIG. 17 illustrates an example PCB mounting footprint for the connector shown in FIG. 6, with dimensions shown in millimeters.

FIG. 18 illustrates another terminal conductor according to various aspects of the embodiments.

FIG. 19 illustrates another terminal conductor according to various aspects of the embodiments.

### DETAILED DESCRIPTION

Connectors are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The wafer assemblies can include an insulative web that supports the terminal conductors in the wafer assemblies. The use of wafer assemblies can be helpful to manufacture connectors capable of high data rates using a range of different assembly processes. It is still challenging, in any case, to design wafers and connectors having the conductor density and small footprint needed for high data rate applications in new systems, while also maintaining the desired electrical characteristics for the transmission of data with integrity.

In the context outlined above, various aspects and embodiments of connectors with contact support structures and other features are described herein.

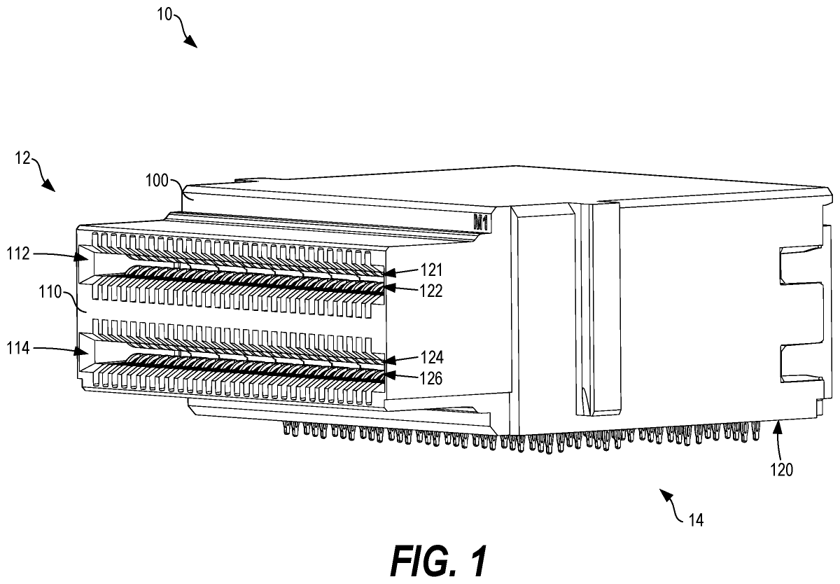

Turning to the drawings, FIG. 1 illustrates a perspective view of an example connector 10. The connector 10 is illustrated as a representative example and is not drawn to any particular scale or size. The shape, size, proportion, and other characteristics of the connector 10 can vary as compared to that shown. Additionally, while the connector 10 and other connectors discussed herein are described for use with 400 Form Factor Pluggable, zCD, or CDFP interconnect systems, the concepts are not limited to use with such cable and interconnect systems. The concepts can be extended to use in other connectors for other types of cable and interconnect systems.

The connector 10 includes a mating end region 12 and a mounting end region 14. The free end of an interconnect system cable can be mated and electrically coupled to the connector 10 at the mating end region 12, as described below. The mounting end region 14 of the connector 10 can be mounted and electrically coupled to a printed circuit board (PCB).

A housing 100 of the connector 10 can be formed from a plastic or other insulating material, in one example, although the housing can also be formed from metal or combinations of insulating and conductive materials in some cases. The housing 100 includes a front port end 110 and a mounting surface 120, among other features. Front port openings 112 and 114 are formed in the front port end 110 of the housing 100. In the example shown, the connector 10 is designed to interface with the PCB-style interface at the free end of a CDFP interconnect system cable or similar cable assembly. The PCB-style interface of the cable can fit and extend into the openings 112 and 114 of the connector 10. Terminal rows 121 and 122 within the front port opening 112 make electrical contact with surface contact regions on the top and bottom surfaces of a PCB interface of the PCB-style tip, when the PCB interface is inserted into the front port opening 112. Additionally, terminal rows 124 and 126 within the front port opening 114 make electrical contact with contacts on the top and bottom surfaces of another PCB interface of the PCB-style tip. In that way, the connector 10 can establish and maintain electrical connections with contacts on the free end interface of a cable assembly.

As described in further detail below, the terminal row 121 includes signal terminal conductors (also “signal conductors”) and ground terminal conductors (also “ground conductors”). In some cases, the terminal row 121 can also include power terminal conductors (also “power conductors”). Each of the conductors in the terminal row 121 includes a lead contact at one distal end (i.e., positioned in the front port opening 112 at the mating end region 12), a tail contact at another distal end (i.e., positioned at the mounting end region 14), and a conductor body that extends between the lead contact and the tail contact. The signal conductors in the terminal row 121 are electrically isolated from each other within the connector 10. The tail contacts of the conductors in the terminal row 121 are formed as through-hole (e.g., “eye of needle” (EON)) contacts, as also described in further detail below. The terminal rows 122, 124, and 126 include conductors similar to those in the terminal row 121, each having a lead contact, a conductor body, and a tail contact.

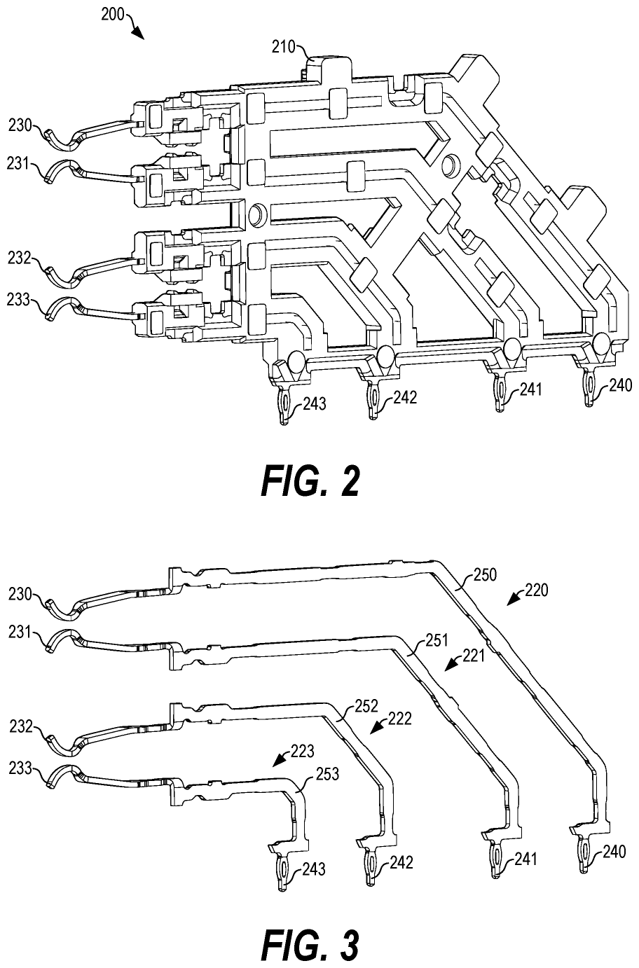

The connector 10 is designed to provide shielding and maintain the signal integrity of differential signals on the terminal conductors in the terminal rows 121, 122, 124, and 126, as they extend from the front port openings 112 and 114 to the mounting end region 14 of the connector 10. Although not visible in FIG. 1, the connector 10 includes a wafer assembly. The wafer assembly holds, positions, electrically isolates, and helps to maintain the signal integrity of the data signals being carried on the conductors in the terminal rows 121, 122, 124, and 126. The wafer assembly includes a number of wafers and terminal conductors arranged in a vertical, rather than a horizontal, configuration. One of the wafers of the wafer assembly in the connector 10 is shown in FIG. 2.

FIG. 2 illustrates an example wafer 200 of the connector 10 shown in FIG. 1, and FIG. 3 illustrates terminal conductors 220-223 of the wafer 200 shown in FIG. 2. The wafer 200 is illustrated as a representative example of one of the wafers among a larger wafer assembly in the connector 10. For example, the wafer 200 can be positioned, side-by-side, with a number of other wafers that are similar to the wafer 200 in the wafer assembly. However, the wafer assembly in the connector 10 can also include a number of other wafers similar to, but different than, the wafer 200. The wafer 200 is arranged in a vertical, rather than a horizontal, configuration.

Referring among FIGS. 2 and 3, the wafer 200 includes a wafer molding 210 and the terminal conductors 220-223. The terminal conductors 220-223 are conductive and can be formed from metal, such as aluminum, copper, zinc, or other metals or metal alloys, and can be plated with one or more plating metals in some cases. The terminal conductors 220-223 extend through the wafer molding 210. Each of the terminal conductors 220-223 can be formed from (e.g., stamped, sheared, or otherwise formed out of) a flat sheet of metal, such as a lead frame. In some cases, the sheet of metal or lead frame can be plated with one or more plating metals. The wafer molding 210 can be formed from a plastic, such as liquid crystal polymer (LCP), polyethylene (PE), polytetrafluoroethylene (PTFE), fluoropolymer, or other plastic or insulating material(s) and is molded around the terminal conductors 220-223. In one example, the wafer molding 210 can be molded around the terminal conductors 220-223 before the terminal conductors 220-223 and the wafer molding 210 are cut or sheared away from a larger lead frame. The terminal conductors 220-223 are physically and electrically separated from each other in the wafer 200.

As noted above, the terminal conductors in the connector 10, including the terminal conductors 220-223, include terminal conductors for data signals, ground, and power in some cases. The terminal conductors 220-223 are terminal conductors for data signals and are representative of the other terminal conductors in the connector 10. The terminal conductors 220-223 include a lead contact at one distal end, a tail contact at another distal end, and a terminal conductor body between the lead contact and the tail contact. More particularly, the terminal conductor 220 includes a lead contact 230, a tail contact 240, and a terminal conductor body 250 between the lead contact 230 and the tail contact 240. The terminal conductor 221 includes a lead contact 231, a tail contact 241, and a terminal conductor body 251 between the lead contact 231 and the tail contact 241. The terminal conductor 222 includes a lead contact 232, a tail contact 242, and a terminal conductor body 252 between the lead contact 232 and the tail contact 242. The terminal conductor 223 includes a lead contact 233, a tail contact 243, and a terminal conductor body 253 between the lead contact 234 and the tail contact 243. The tail contacts 240-243 of the terminal conductors 220-223, respectively, are formed as through-hole or EON tail contacts. When the mounting end region 14 of the connector 10 (see FIG. 1) is mounted and electrically coupled to a PCB board, the tail contacts 240-243 of the terminal conductors 230-234, among other tail contacts of the connector 10, can be inserted through plated vias or through holes of the PCB and, in some cases, soldered in place.

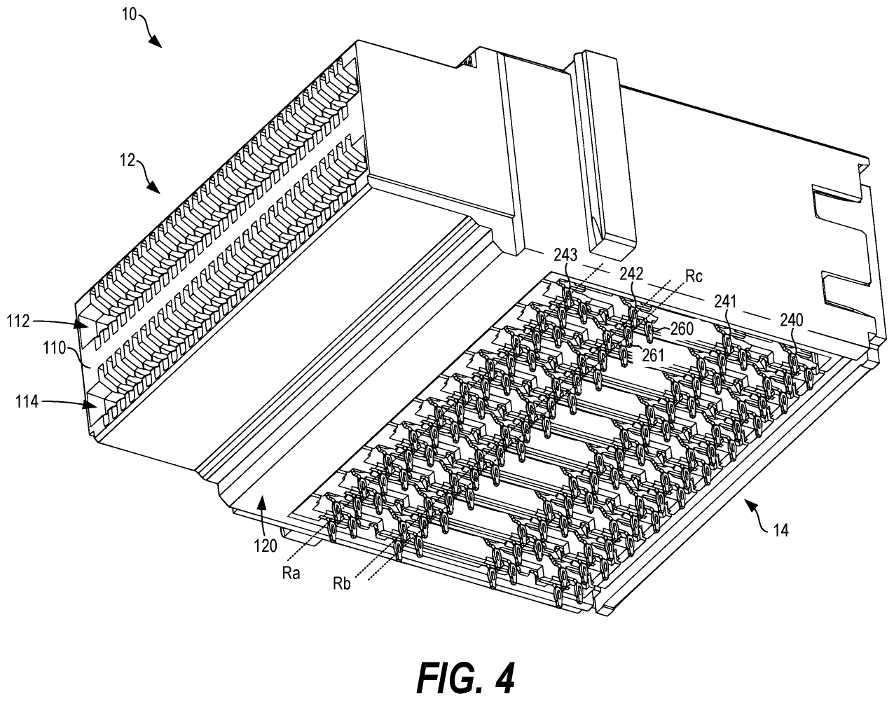

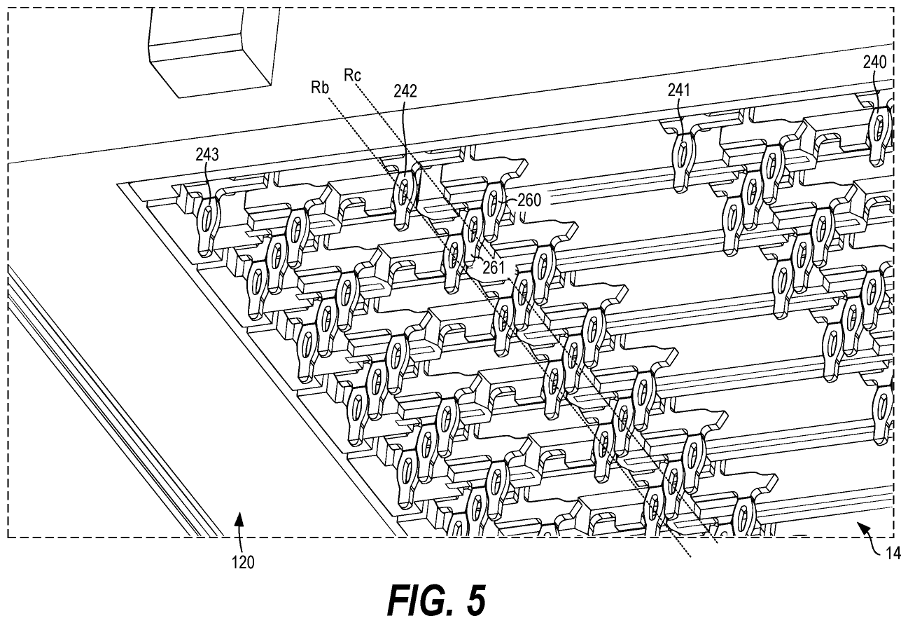

FIG. 4 illustrates a bottom perspective view of the connector 10 shown in FIG. 1, and FIG. 5 illustrates another bottom perspective view of the connector 10 shown in FIG. 1. The mounting end region 14 of the connector 10 is shown in greater detail in FIGS. 4 and 5. Among other features, the tail contacts 240-243 of the terminal conductors 220-223 (see FIGS. 2 and 3) of the connector 10 are shown. The connector 10 includes rows “Ra,” “Rb,” and “Rc” of tail contacts, among other rows of tail contacts. Each of the tail contacts in the mounting end region 14 is formed as a through-hole or EON contact in the connector 10. In the example shown, the tail contact 243 is positioned at one end of the row “Ra,” and the tail contact 242 is positioned at one end of the row “Rb.” The rows “Ra,” “Rb,” and “Rc” of tail contacts are staggered apart from each other (i.e., offset in distance from the front to the back of the region 14).

The terminal conductors 230-234 are data signal conductors in the connector 10, but the connector 10 also includes other terminal conductors for ground. For example, the tail contact 260 is a tail contact for another data signal conductor of the connector 10, and the tail contact 261 is a tail contact for a ground conductor of the connector 10. In the connector 10, all of the tail contacts for ground conductors are arranged in a row that is separate from any row in which data signal tail contacts extend. In other words, the ground tail contact 261 extends in the row “Rc,” and other ground tail contacts of the connector 10 also extend in the row “Rc.” However, no data signal contacts of the connector 10 extend in the row “Rc.” Similarly, the data signal tail contact 242 extends in the row “Rb,” and other data signal tail contacts also extend in the row “Rb.” However, no ground tail contacts of the connector 10 extend in the row “Rb.”

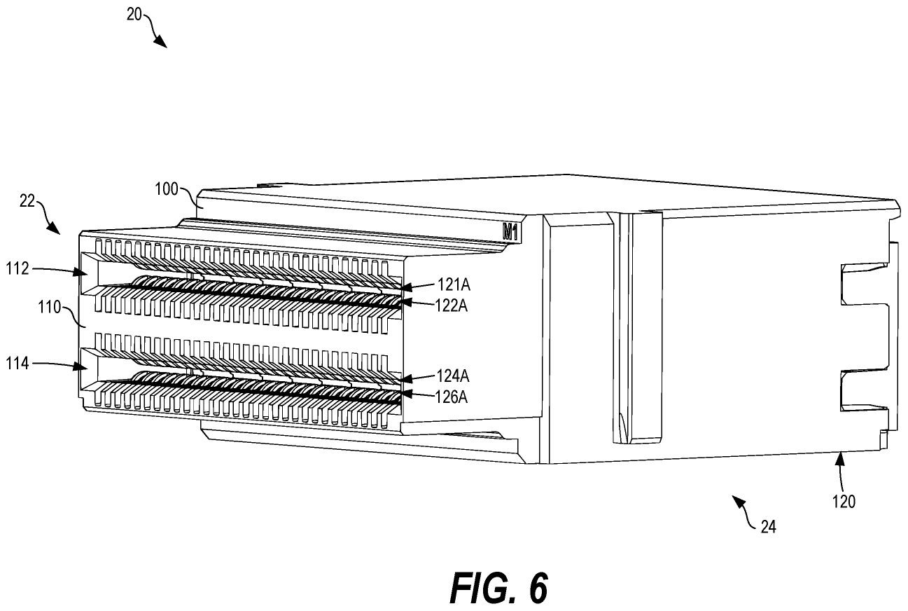

Turning to other examples, FIG. 6 illustrates a perspective view of an example connector 20. The connector 20 is illustrated as a representative example and is not drawn to any particular scale or size. The shape, size, proportion, and other characteristics of the connector 20 can vary as compared to that shown. Additionally, while the connector 20 is described for use with CDFP interconnect systems, the concepts described herein are not limited to use with such cable and interconnect systems. The concepts can be extended to use in other connectors for other types of cable and interconnect systems.

The connector 20 includes a mating end region 22 and a mounting end region 24. The free end of an interconnect system cable can be mated and electrically coupled to the connector 20 at the mating end region 22. The mounting end region 24 of the connector 20 can be mounted and electrically coupled to a printed circuit board (PCB). As compared to the connector 10 shown in FIG. 1, the mating end region 22 of the connector 20 includes surface mount (SMT) tail contacts rather than through-hole or EON tail contacts.

The connector 20 includes a housing 100 similar to that of the connector 10 shown in FIG. 1. The housing 100 can be formed from a plastic or other insulating material, in one example, although the housing can also be formed from metal or combinations of insulating and conductive materials in some cases. The housing 100 includes a front port end 110 and a mounting surface 120, among other features. Front port openings 112 and 114 are formed in the front port end 110 of the housing 100. The connector 20 is designed to interface with the PCB-style interface at the free end of a CDFP interconnect system cable or similar cable assembly. The PCB-style interface of the cable can fit and extend into the openings 112 and 114 of the connector 20. Terminal rows 121A and 122A within the front port opening 112 make electrical contact with surface contact regions on the top and bottom surfaces of a PCB interface of the PCB-style tip, when the PCB interface is inserted into the front port opening 112. Additionally, terminal rows 124A and 126A within the front port opening 114 make electrical contact with contacts on the top and bottom surfaces of another PCB interface of the PCB-style tip. In that way, the connector 20 can establish and maintain electrical connections with contacts on the free end interface of a cable assembly.

As described in further detail below, the terminal row 121A includes signal terminal conductors (also “signal conductors”) and ground terminal conductors (also “ground conductors”). In some cases, the terminal row 121A can also include power terminal conductors (also “power conductors”). Each of the conductors in the terminal row 121A includes a lead contact at one distal end (i.e., positioned in the front port opening 112 at the mating end region 22), a tail contact at another distal end (i.e., positioned at the mounting end region 24), and a conductor body that extends between the lead contact and the tail contact. The signal conductors in the terminal row 121A are electrically isolated from each other within the connector 20. The tail contacts of the conductors in the terminal row 121A are formed as SMT contacts, as also described in further detail below. The terminal rows 122A, 124A, and 126A include conductors similar to those in the terminal row 121A, each having a lead contact, a conductor body, and a tail contact.

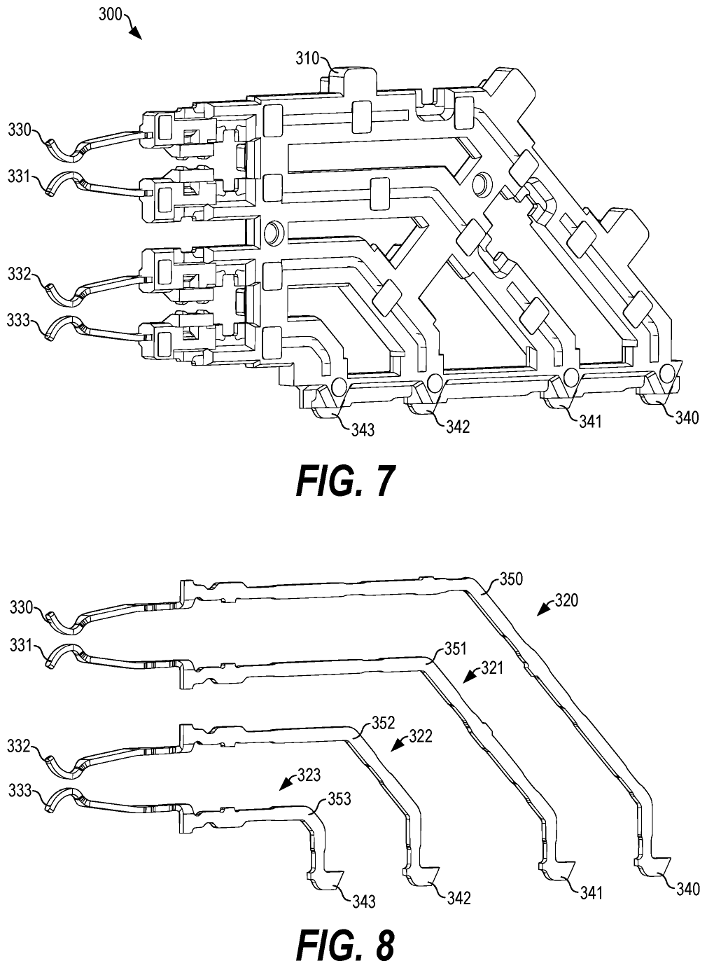

The connector 20 is designed to provide shielding and maintain the signal integrity of differential signals on the terminal conductors in the terminal rows 121A, 122A, 124A, and 126A, as they extend from the front port openings 112A and 114A to the mounting end region 24 of the connector 20. Although not visible in FIG. 6, the connector 20 includes a wafer assembly. The wafer assembly holds, positions, electrically isolates, and helps to maintain the signal integrity of the data signals being carried on the conductors in the terminal rows 121A, 122A, 124A, and 126A. The wafer assembly includes a number of wafers and terminal conductors arranged in a vertical, rather than a horizontal, configuration. One of the wafers of the wafer assembly in the connector 20 is shown in FIG. 7.

FIG. 7 illustrates an example wafer 300 of the connector 20 shown in FIG. 6, and FIG. 8 illustrates terminal conductors 320-323 of the wafer 300 shown in FIG. 7. The wafer 300 is illustrated as a representative example of one of the wafers among a larger wafer assembly in the connector 20. For example, the wafer 300 can be positioned, side-by-side, with a number of other wafers that are similar to the wafer 300 in the wafer assembly. However, the wafer assembly in the connector 20 can also include a number of other wafers similar to, but different than, the wafer 300. The wafer 300 is arranged in a vertical, rather than a horizontal, configuration.

Referring among FIGS. 7 and 8, the wafer 300 includes a wafer molding 310 and the terminal conductors 320-323. The terminal conductors 320-323 are conductive and can be formed from metal, such as aluminum, copper, zinc, or other metals or metal alloys, and be plated with one or more plating metals in some cases. The terminal conductors 320-323 extend through the wafer molding 310. Each of the terminal conductors 320-323 can be formed from (e.g., stamped, sheared, or otherwise formed out of) a flat sheet of metal, such as a lead frame. In some cases, the sheet of metal or lead frame can be plated with one or more plating metals. The wafer molding 310 can be formed from a plastic, such as LCP or other insulating material(s) and is molded around the terminal conductors 320-323. In one example, the wafer molding 310 can be molded around the terminal conductors 320-323 before the terminal conductors 320-323 and the wafer molding 310 are cut or sheared away from a larger lead frame. The terminal conductors 320-323 are physically and electrically separated from each other in the wafer 300.

The terminal conductors in the connector 20, including the terminal conductors 320-323, include terminal conductors for data signals, ground, and power in some cases. The terminal conductors 320-323 are terminal conductors for data signals and are representative of the other terminal conductors in the connector 20. The terminal conductors 320-323 include a lead contact at one distal end, a tail contact at another distal end, and a terminal conductor body between the lead contact and the tail contact. More particularly, the terminal conductor 320 includes a lead contact 330, a tail contact 340, and a terminal conductor body 350 between the lead contact 330 and the tail contact 340. The terminal conductor 321 includes a lead contact 331, a tail contact 341, and a terminal conductor body 351 between the lead contact 331 and the tail contact 341. The terminal conductor 322 includes a lead contact 332, a tail contact 342, and a terminal conductor body 352 between the lead contact 332 and the tail contact 342. The terminal conductor 323 includes a lead contact 333, a tail contact 343, and a terminal conductor body 353 between the lead contact 334 and the tail contact 343.

The tail contacts 340-343 of the terminal conductors 320-323, respectively, are formed as SMT tail contacts. When the mounting end region 24 of the connector 20 (see FIG. 6) is mounted and electrically coupled to a PCB board, the tail contacts 340-343 of the terminal conductors 320-323, among other tail contacts of the connector 20, can be positioned on (i.e., rested upon or contacted with) surface mount contact pads of a PCB and soldered in place. The tail contacts 340-343, being formed as SMT tail contacts, can provide improved signal integrity performance for the connector 20 as opposed to the EON tail contacts 240-243 of the connector 10 in some cases.

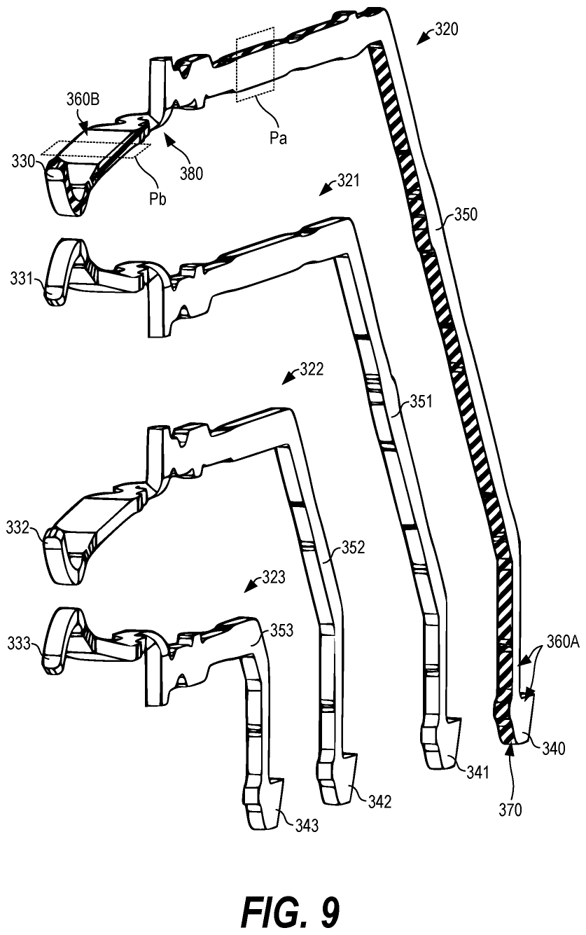

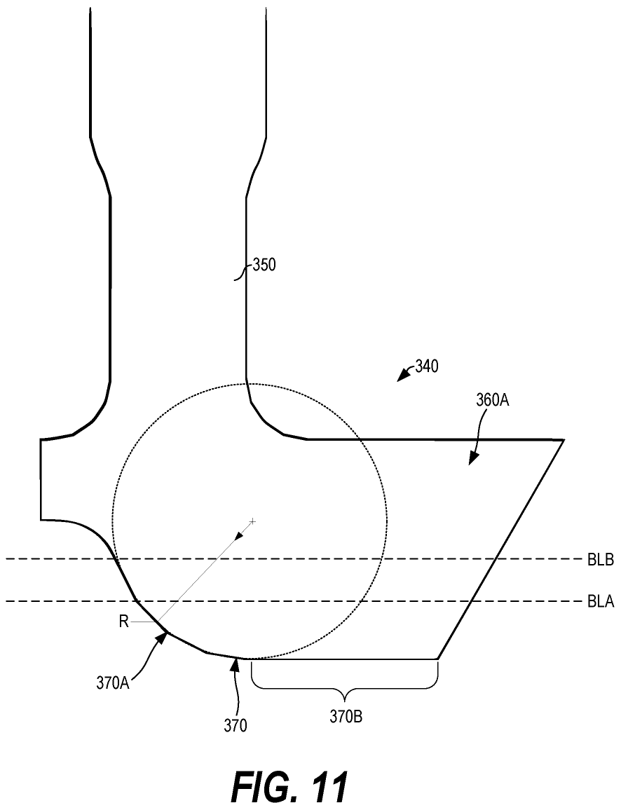

FIG. 9 illustrates another view of the terminal conductors 320-323 shown in FIG. 8. Referring particularly to the terminal conductor 320, the terminal conductor 320 includes side surfaces 360A and 360B, a cut edge surface 370, and a body bend 380. The body bend 380 is positioned along the terminal conductor body 350 of the terminal conductor 320. Although not shown in FIG. 9, the terminal conductors 320-323 can include additional body bends in some cases. For example, the tail contacts 340-343 of the terminal conductors 320-323 can include body bends, as also described below with reference to FIG. 11.

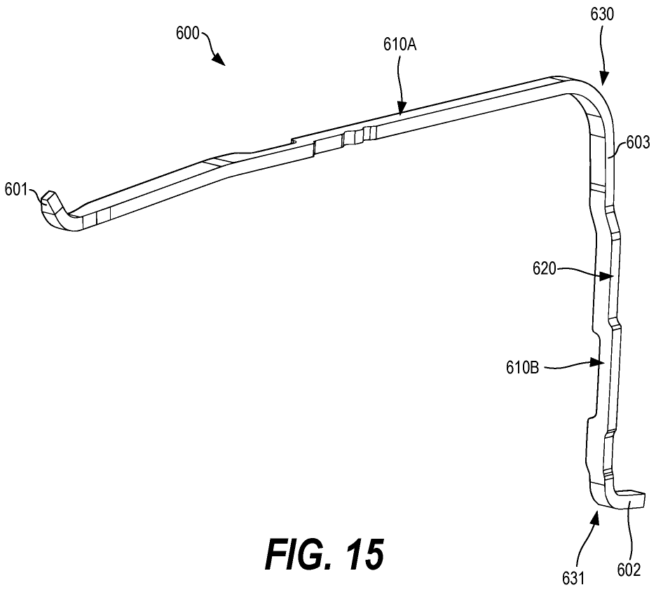

The side surfaces 360A and 360B are original surfaces of a lead frame from which the terminal conductor 320 is formed. Over the entire length of the terminal conductor 320, the side surfaces 360A and 360B face away from other and extend in planes that are parallel to each other, including over the body bend 380. In the connector 20, the side surface 360A extends in a plane “Pa” that is substantially parallel or orthogonal to a plane in which the mounting surface 120 (see FIG. 6) of the housing 100 extends. Thus, the terminal conductor 320 is said to extend vertically, rather than horizontally, in the connector 20. An example of a terminal cut from a lead frame that extends horizontally is described below with reference to FIG. 15.

To be distinguished from the side surfaces 360A and 360B, the cut edge surface 370 is an edge surface formed from shearing or cutting out the terminal conductor 320 from the lead frame. The cut edge surface 370 is a single continuous surface of the terminal conductor 320, extending peripherally around it, and includes both flat and curved surfaces. The bottom edges of each of the tail contacts 340-343 are cut edge surfaces, and those cut edge surfaces can rest upon and contact the top surface of a PCB board upon which the connector 20 is surface mounted according to the embodiments.

The terminal conductor 320 is bent or rotated at the body bend 380. As an example, the material of the terminal conductor 320 is bent or rotated by about 90 degrees over the body bend 380. The body bend 380 permits the lead contact 330 and the lead end of the terminal conductor 320 to bend or flex to some extent, for electrical coupling to a PCB-style interface at a free end of a CDFP interconnect system cable. Thus, at the lead end of the terminal conductor 320, the side surface 360B extends in a plane “Pb” that is orthogonal to the plane “Pa”.

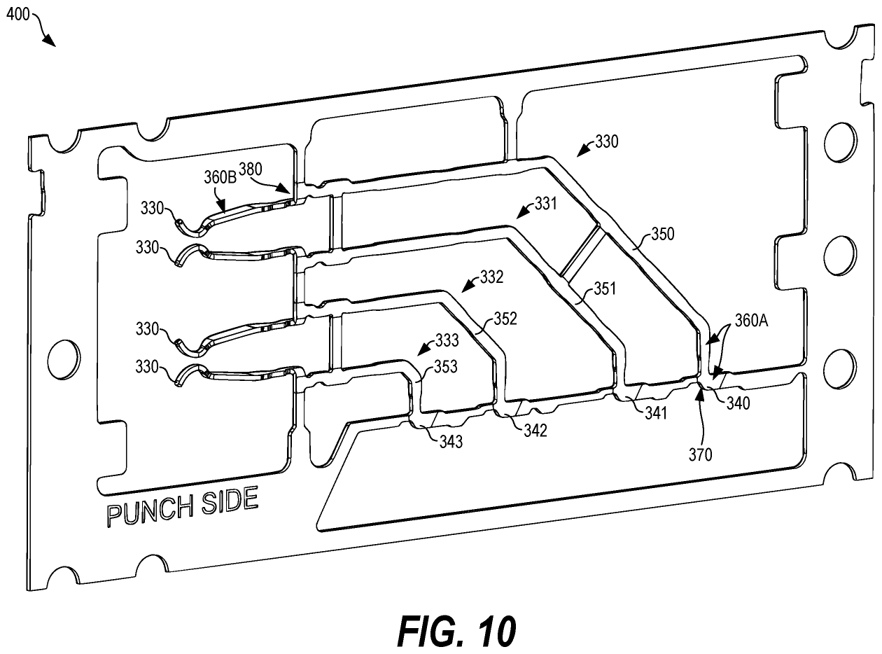

FIG. 10 illustrates an example lead frame 400 for the terminal conductors 320-323 in the connector 20 shown in FIG. 6. The lead frame 400 is conductive and can be formed from metal, such as aluminum, copper, zinc, or other metals or metal alloys, and can be plated with one or more plating metals in some cases. The lead frame 400 starts from a sheet of conductive material, and regions of the sheet are cut or sheared away to leave the terminal conductors 320-323 remaining as shown. The sheet of material can range in thickness from between 0.10-0.25 mm, for example, although other thicknesses can be relied upon. As particular examples, the sheet of material for the lead frame can be 0.15 mm, 0.16 mm, 0.17 mm, 0.18 mm, 0.19 mm, 0.20 mm, 0.21 mm, 0.22 mm, or 0.23 mm in thickness. The side surfaces 360A and 360B are original surfaces of the original sheet of conductive material of the lead frame 400. The cut edge surface 370 is an edge surface formed from shearing or cutting out the original sheet of conductive material of the lead frame 400.

The lead frame 400, as shown in FIG. 10, can be inserted into a mold and a plastic, such as LCP or other insulating material(s), and can be molded around the lead frame 400 to form the wafer molding 310 shown in FIG. 7. After the wafer molding 310 is formed around the terminal conductors 320-323, the terminal conductors 320-323 and the wafer molding 310 can be removed from the remainder of the lead frame 400 through a subsequent cutting or shearing step.

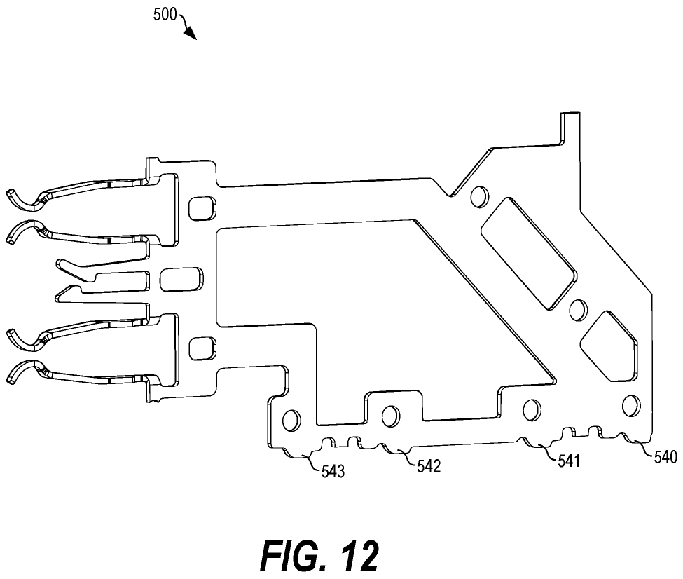

FIG. 11 illustrates the tail contact 340 in the connector 20 shown in FIG. 6 according to various aspects of the present disclosure. Particularly, FIG. 11 illustrates a side profile of the tail contact 340. The side profile of the tail contact 340 is shown as a representative example in FIG. 11, and the tail contacts 341-343 can have similar profiles. However, the tail contacts 340-343 can have different profiles as compared to that shown in FIG. 11. The connector 20 can also include SMT tail contacts having a combination of different profiles, such as different profiles for signal, ground, and power SMT tail contacts. For example, FIG. 12 illustrates SMT tail contacts of a ground conductor frame 500 for the connector 20 having a side profile that is different than that shown in FIG. 11.

As shown in FIG. 11, the tail contact 340 includes the side surface 360A and the cut edge surface 370. The side surface 360A is an original surface of the sheet of conductive material of the lead frame 400. The cut edge surface 370 is an edge surface formed from shearing or cutting out the original sheet of conductive material of the lead frame 400. The cut edge surface 370 includes a rounded edge surface region 370A and an extended edge surface region 370A over the tail contact 340. The rounded edge 370A has a bend radius “R,” which can range from between 0.2-0.5 mm, for example, although other dimensions can be relied upon. As particular examples, the bend radius “R” can be 0.30 mm, 0.31 mm, 0.32 mm, 0.33 mm, 0.33 mm, 0.34 mm, 0.35 mm, 0.36 mm, 0.37 mm, 0.38 mm, 0.39 mm, or 0.40 mm. The extended edge 370A is flat or planar in one example, and the extended edge 370A is a primary surface of the tail contact 340 for electrical surface mount coupling to a surface mount contact pad on a PCB.

The tail contact 340 does not include a bend in the side surface 360A (or the side surface 360B) in the example shown in FIG. 11. However, the tail contact 340 can include a bend in the side surface 360A in some cases. For example, the tail contact 340 can be bent along the bend line “BLA” or the bend line “BLB” shown in FIG. 11. Such a bend may be similar to the body bend 380 shown in FIG. 9, but formed in the tail contact 340. In that case, the side surface 360A (or the opposite side surface 360B) would be a primary surface of the tail contact 340 for electrical surface mount coupling to a surface mount contact pad on a PCB. The bend lines “BLA” and “BLB” extend in the front-to-back direction of the connector 20 rather than in the side-to-side direction.

FIG. 12 illustrates a ground conductor frame 500 in the connector 20 shown in FIG. 6 according to various aspects of the present disclosure. The ground conductor frame 500 includes ground tail contacts 540-543, which are formed as SMT tail contacts. When the mounting end region 24 of the connector 20 (see FIG. 6) is mounted and electrically coupled to a PCB board, ground tail contacts 540-543 of the ground conductor frame 500, among others, can be surface mounted to PCB contacts and soldered in place. The ground conductor frame 500 can also be formed from a lead frame similar to the lead frame 400 shown in FIG. 10. Thus, the ground conductor frame 500 also include side surfaces and cut edge surfaces.

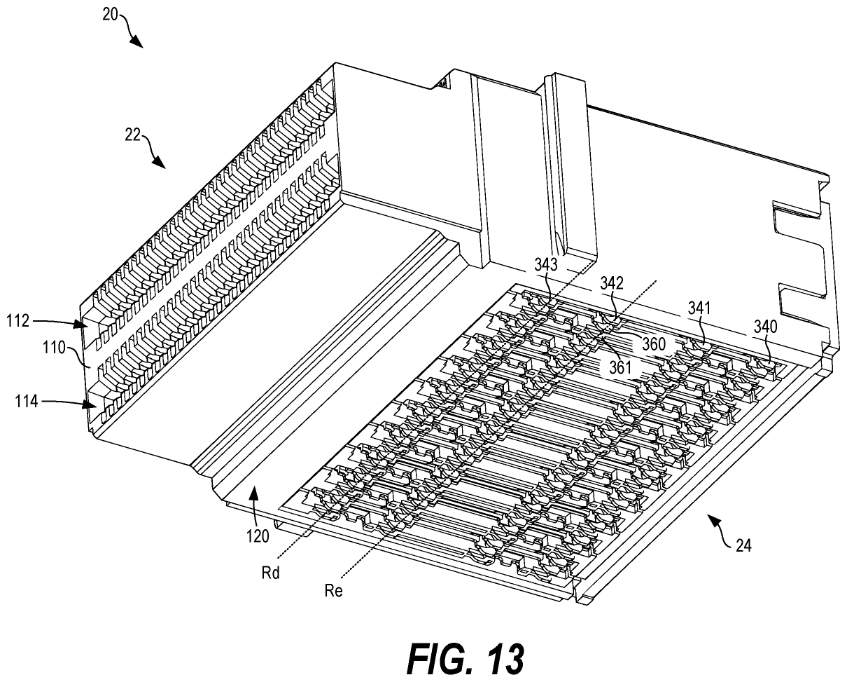

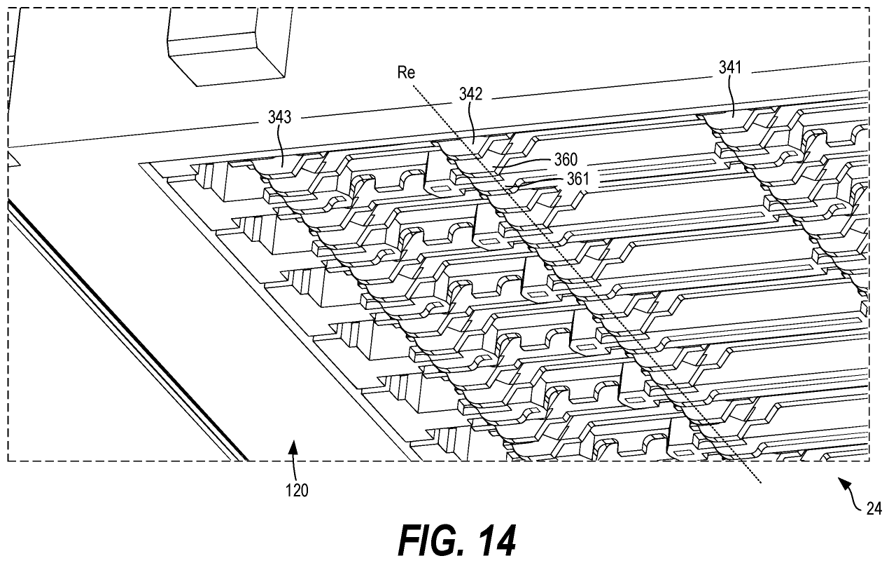

FIG. 13 illustrates a bottom perspective view of the connector 20 shown in FIG. 6, and FIG. 14 illustrates another bottom perspective view of the connector 20 shown in FIG. 6. The mounting end region 24 of the connector 20 is shown in greater detail in FIGS. 13 and 14. Among other features, the tail contacts 340-343 of the terminal conductors 220-223 (see FIGS. 7 and 8) of the connector 20 are shown. The connector 20 includes rows “Rd” and “Re” of tail contacts, among other rows of tail contacts. Each of the tail contacts in the mounting end region 24 is formed as an SMT contacts in the connector 20. In the example shown, the tail contact 343 is positioned at one end of the row “Rd,” and the tail contact 342 is positioned at one end of the row “Re.” The rows “Rd” and “Re” are staggered apart from (i.e., offset in distance from the front to the back of the region 24) each other.

The terminal conductors 330-334 are data signal conductors in the connector 20, but the connector 20 also includes other terminal conductors for ground. For example, the tail contact 360 is a tail contact for another data signal conductor of the connector 20, and the tail contact 361 is a tail contact for a ground conductor of the connector 20. In the connector 20, tail contacts for ground conductors are arranged, inline, in the same row that data signal tail contacts extend. In other words, the ground tail contact 361 extends in the row “Re,” and other ground tail contacts of the connector 20 also extend in the row “Re.” Additionally, data signal contacts of the connector 20, such as the tail contact 342, also extend in the row “Re.” Thus, in the connector 20, a single, inline row of SMT tail contacts can include a combination of ground and data tail contacts. A single row of SMT tail contacts can also include a combination of ground, data, and power tail contacts in some cases. This contrasts with the design of the connector 10 shown in FIG. 4, in which all the tail contacts for ground conductors are arranged in a row that is separate from any row in which data signal tail contacts extend.

FIG. 15 illustrates a horizontal style terminal conductor 600 according to various aspects of the embodiments. The terminal conductor 600 can be used in a connector, but it is not relied upon in the connectors 10 or 20. The terminal conductor 600 includes a lead contact 601, a tail contact 602, and a terminal conductor body 603 extending between the lead contact 601 and the tail contact 602. The terminal conductor 600 includes side surfaces 610A and 610B, a cut edge surface 620, and body bends 630 and 631. The side surfaces 610A and 610B are original surfaces of a lead frame from which the terminal conductor 600 is formed. Over the entire length of the terminal conductor 600, the side surfaces 610A and 610B face away from one another and extend in planes that are parallel to each other, including over the body bends 630 and 631. To be distinguished from the side surfaces 610A and 610B, the cut edge surface 620 is an edge surface formed from shearing or cutting out the terminal conductor 600 from a lead frame. The cut edge surface 620 is a single continuous surface of the terminal conductor 600, extending peripherally around it, and includes both flat and curved surfaces.

At the tail contact 602, the side surface 610A is bent over the body bend 631 to form an SMT tail. In this configuration, the side surface 610A can rest upon and contact the top surface of a PCB board for making an electrical connection with the PCB. The configuration of the horizontal style terminal conductor 600 shown in FIG. 9 is thus different than the vertical style terminal conductors in the connector 20. Particularly, the side surface 610A and not the cut edge surface 620 of the terminal connector 600 is the primary surface of the tail contact 340 for electrical surface mount coupling to a PCB.

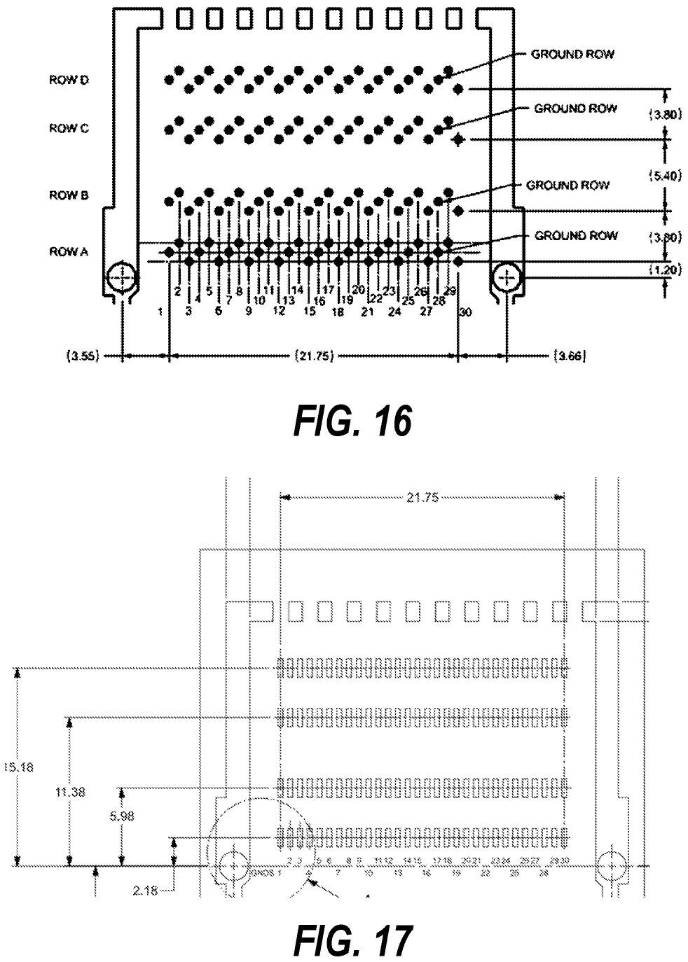

FIG. 16 illustrates an example PCB mounting footprint for the connector 10 shown in FIG. 1, with dimensions shown in millimeters, and FIG. 17 illustrates an example PCB mounting footprint for the connector 20 shown in FIG. 6 with dimensions shown in millimeters.

FIG. 17 illustrates another terminal conductor 700 according to various aspects of the embodiments. The terminal conductor 700 can be used in a connector similar to the connectors 10 or 20. The terminal conductor 700 includes a lead contact 701, a tail contact 702, and a terminal conductor body 703 extending between the lead contact 701 and the tail contact 702. The terminal conductor 700 includes side surfaces 710A and 710B, a cut edge surface 720, and body bends 730 and 731. The side surfaces 710A and 710B are original surfaces of a lead frame from which the terminal conductor 700 is formed. Over the entire length of the terminal conductor 700, the side surfaces 710A and 710B face away from one another and extend in planes that are parallel to each other, including over the body bends 730 and 731. To be distinguished from the side surfaces 710A and 710B, the cut edge surface 720 is an edge surface formed from shearing or cutting out the terminal conductor 700 from a lead frame. The cut edge surface 720 is a single continuous surface of the terminal conductor 700, extending peripherally around it, and includes both flat and curved surfaces. At the tail contact 702, the side surface 710A is bent over the body bend 731 to form an SMT tail. In this configuration, the side surface 710A can rest upon and contact the top surface of a PCB board for making an electrical connection with the PCB.

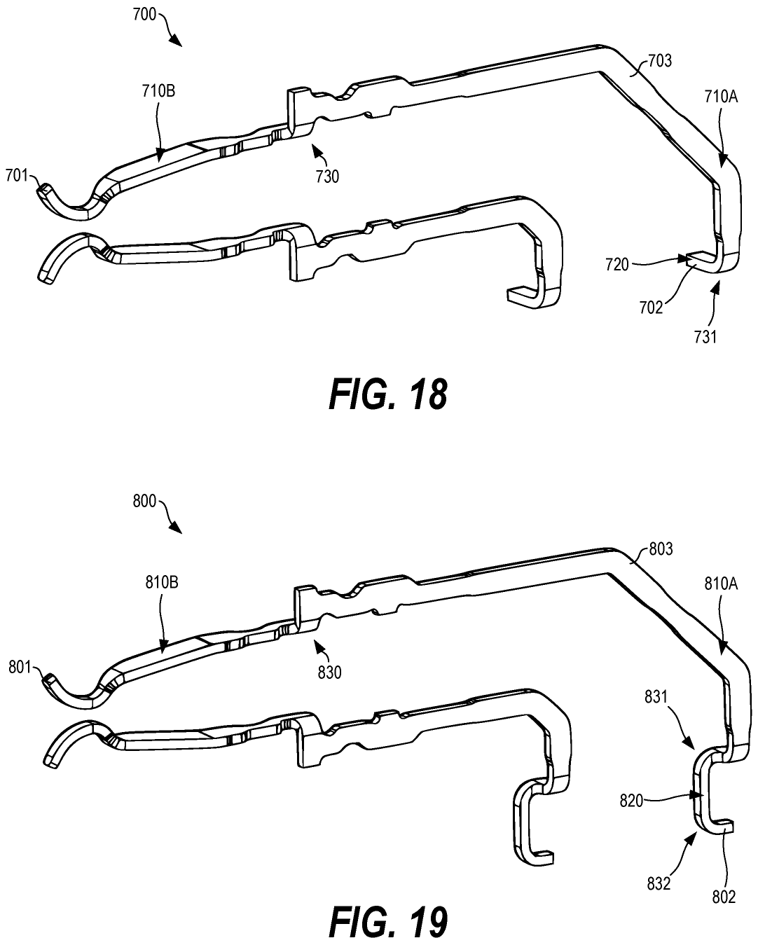

FIG. 18 illustrates another terminal conductor 800 according to various aspects of the embodiments. The terminal conductor 800 can be used in a connector similar to the connectors 10 or 20. The terminal conductor 800 includes a lead contact 801, a tail contact 802, and a terminal conductor body 803 extending between the lead contact 801 and the tail contact 802. The terminal conductor 800 includes side surfaces 810A and 810B, a cut edge surface 820, and body bends 830, 831, and 832. The side surfaces 810A and 810B are original surfaces of a lead frame from which the terminal conductor 800 is formed. Over the entire length of the terminal conductor 800, the side surfaces 810A and 810B face away from one another and extend in planes that are parallel to each other, including over the body bends 830 and 831. To be distinguished from the side surfaces 810A and 810B, the cut edge surface 820 is an edge surface formed from shearing or cutting out the terminal conductor 800 from a lead frame. The cut edge surface 820 is a single continuous surface of the terminal conductor 800, extending peripherally around it, and includes both flat and curved surfaces. At the tail contact 802, the side surface 810B is bent over the body bends 831 and 832 to form an SMT tail. In this configuration, the side surface 810B can rest upon and contact the top surface of a PCB board for making an electrical connection with the PCB.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A connector, comprising:
a housing;
a wafer comprising a terminal conductor, the terminal conductor comprising a lead contact, a tail contact, and a terminal conductor body extending between the lead contact and the tail contact, wherein:
the wafer and the terminal conductor are arranged vertically in the connector; and
the tail contact of the terminal conductor comprises a surface mount tail contact.

2. The connector according to claim 1, wherein the terminal conductor comprises a side surface, a cut edge surface, and a body bend along the terminal conductor body.

3. The connector according to claim 1, wherein the surface mount tail contact comprises a side surface and a surface mount cut edge surface.

4. The connector according to claim 1, wherein the surface mount tail contact comprises a side surface and a surface mount cut edge surface without a bend in the side surface.

5. The connector according to claim 4, wherein the surface mount cut edge surface is an edge surface formed from shearing or cutting the terminal conductor out from a lead frame.

6. A connector, comprising:
a housing;
a wafer assembly comprising a plurality of wafers and a plurality of terminal conductors, each terminal conductor among the plurality of terminal conductors comprising a lead contact, a tail contact, and a terminal conductor body extending between the lead contact and the tail contact, wherein:
the plurality of wafers are arranged vertically in the wafer assembly;
each tail contact of the plurality of terminal conductors comprises a surface mount tail contact; and
each surface mount tail contact is arranged in a linear row extending along a mounting end region of the connector.

7. The connector according to claim 6, wherein each surface mount tail contact comprises a side surface and a surface mount cut edge surface.

8. The connector according to claim 6, wherein each surface mount tail contact comprises a side surface and a surface mount cut edge surface without a bend in the side surface.

9. The connector according to claim 6, wherein the mount tail contacts arranged in the linear row comprise a combination of data and ground tail contacts.

10. The connector according to claim 1, wherein the surface mount tail contact is rested upon or contacted with a surface mount contact pad of a printed circuit board (PCB) and is soldered in place.
